(19) United States
(12) Patent Application Publication
(10) Pub. No.: US 2006/0214073 A1
(43) Pub. Date: Sep. 28, 2006

(54) Fabricated heavy duty structural clamp

(76) Inventors: Daniel S. Mominee, Chandler, AZ (US); Raymond M. Olle, Brecksville, OH (US); Raymond S. Laughlin, Middlefield, OH (US)

Correspondence Address: John W. Renner;Renner, Otto, Boisselle & Sklar, LLP, Nineteenth Floor, 1621 Euclid Avenue, Cleveland, OH, 44115, US

(21) Appl. No.: 11/087,026

(22) Filed: Mar. 22, 2005

(51) Int. Cl. F16M 11/16

(52) U.S. Cl. 248/226.11

(57) ABSTRACT

A fabricated heavy duty structure clamp hanger uses a spacer block with a primary opening threaded hole accommodating a clamp screw. The block is secured between side plates each having a notch which extends beneath the hole so that a structure flange and the like may be inserted in the notch and clamped thereto by the screw. The clamp accommodates one or more threaded rods through other primary openings or holes, which may be in one or more spacer blocks. The blocks may be fabricated from laminations and the side plates may include at least two plates on each side. The structure is utilized with swaged or peened pins or projections extending through the side plates to provide a heavy duty hanger clamp having all of the advantages of castings but none of the problems and cost.

This invention relates generally as indicated to a fabricated heavy duty structural clamp, and more particularly to a low cost yet light weight heavy duty clamp using primarily threaded rod for fixing and hanging a variety of items such as pipe, lighting and heating fixtures, duct work, cables or cable trays from a variety of structural members such as beams, struts, Z-purlin, T-bars, or other structural shapes.

### BACKGROUND OF THE INVENTION

Heavy duty clamps such as beam clamps are often used as hangers and have a notch or jaw opening receiving an edge of a structure flange such as a beam. The upper part of the jaw is provided with a clamping bolt or set screw directed to the lower or bottom jaw. A flange fits in the jaw and as the clamping bolt or screw is tightened against the top of the flange the clamp is secured to the flange of the structure. An object supported by the clamp is often supported by a threaded rod which may extend through a nut or thread form in the body of the clamp clear of the edge of the flange. However some clamps secure the rod to a thread form in the bottom of the jaw in alignment with the clamping bolt. Other items are hung or supported with intermediate fixtures to support wiring, conduit, swivel connections or even struts.

Heavy duty clamps used in the construction industry have long been made from castings, usually cast iron. These castings were typically made by smaller job shop foundries. Over the last several decades these foundries have disappeared from the American industrial scene, primarily because of costly environmental restrictions. Today most castings of the type in question are made overseas and primarily in Asia. The long transportation costs makes even the raw casting expensive even before it is subjected to further expensive machining such as drilling, taping, cutting or finishing. However, even in Asia environmental considerations are beginning to impact such industries making job shop castings even more difficult or expensive to obtain. Complicating the matter further is that heavy duty clamps may vary widely in size dimensions, such as height and width, and other dimensions which makes the procurement of castings for such heavy duty clamps much more difficult. Also, the material properties of castings can vary widely from run to run even from the same source, leading to unpredictable clamp performance.

Heavy duty clamps are typically commodity items that have a cast iron body with a variety of threaded or plain primary openings to accept threaded rod, and a set screw/jam nut combination for affixing the clamp to a structural member, and may include secondary openings to accommodate intermediate fasteners such as bridle rings or conduit clamps.

As a result of this trend a number of smaller lighter weight clamps are being fabricated from relatively thin sheet metal. Examples of these smaller clamps are sold under the well known CADDY® trademark by ERICO International Corporation of Solon, Ohio, U.S.A. under the part numbers BC. However larger heavy duty beam and other type clamps are still made from castings.

There is accordingly a need for a sturdy and yet versatile low cost fabricated heavy duty yet light weight clamp which will provide the same advantages as cast iron for example, but at a lower cost and more reliable uniform quality.

### SUMMARY OF THE INVENTION

In one preferred embodiment of a heavy duty structure hanger clamp in accordance with the invention, a spacer block has at least one hole with side plates secured to the spacer block, and each having a notch having one side extending beneath the hole. Threads in the hole receive a clamp screw to clamp a structure against the one side of the notch to secure the clamp to the structure. An opening between the side plates offset from the hole and the notches enables something to be supported from the clamp offset and clear of the structure. The side plates may be formed from a continuous U-shape plate and a threaded rod extends through the opening and a clasp or clip is positioned on the rod interfitting with the plates to capture the clasp and rod. The clasp may be a common nut or push nut, or a slip-on nut of the type seen in Applicant's Assignee's U.S. Pat. No. 6,050,766. A slot may be provided in the plates to capture the clasp or nut.

In another preferred form of the invention, the heavy duty fabricated hanger clamp of the invention comprises a spacer block having at least one primary hole. Side plates are secured to the spacer block and each side plate has a notch having one side, usually the bottom, extending beneath the primary hole. Threads are formed in the primary hole to accommodate a clamp screw which, when tightened, will clamp a structure flange and the like accommodated in the notch against the far side of the notch.

The same block or another block may include another primary hole clear of the interior of the notch which will accommodate a threaded rod projecting past the edge of the structure flange or any other structure clamped in the notch. The other primary hole may be threaded or un-threaded. If threaded the threads may mesh with the rod if sized matched. If the threads are larger or the hole is un-threaded the rod will project through and be held in suspended vertical position by a variety of devices, which may range from a nut threaded on the rod, with or without a lock nut, to a jam nut, a spring steel bobby pin clip, or a two part slip-on nut such as seen in the noted prior U.S. Pat. No. 6,050,766.

Some clamps may be provided with two primary holes vertically aligned accommodating threaded rod, one above the other. One may be threaded and one not. If two vertically spaced holes are provided clear of the structure flange, an additional spacer block is provided for the additional hole although both offset holes may be provided in a single, vertically extended block.

For some heavy duty hangers it is desired to position the hanging rod in vertical alignment with the clamp screw, and a spacer block with a threaded hole may be provided between the side plates bridging the bottom edge of the notch with a threaded primary hole aligned with the primary hole accommodating the clamp screw. The top of the threaded rod is then threaded into the threaded primary hole beneath the notch and tightened against the structure or flange in the notch further clamping the hanger in place.

By primary hole is meant a hole accommodating either a threaded rod or the clamping screw. It will be appreciated that the various spacing blocks may be provided with other holes, usually smaller, threaded and un-threaded, which may accommodate a variety of intermediate fasteners such as bridle rings, conduit clamps, or drop wire attachments.

For strength each side plate may be two or more side plates. The various spacer blocks positioned between the side plates may be machined and cut from longer standard stock with the holes formed before or after assembly. Also the blocks may be formed or built up from vertical laminations of plates with the width of the heavy duty clamp determined by the number of laminations. A block thus constructed may be provided between the far side or bottom of the notch or clamping jaw to provide a larger and more effective clamping area opposite the clamp screw. A block of this type may or may not be provided with the primary threaded hole for the threaded rod as discussed above.

If formed of the laminations indicated the assembly with the side plates may be accomplished by through-pins or rivets which may be assembled in a pressing or stamping operation. Even with machined blocks it is preferred to provide those blocks with projections or wings which will project through notches or holes in the side plates with the projecting ends being coined, pressed or swaged to complete the assembly. Although not necessarily preferred, the laminated plates and side plates may be secured together by welding or bolting or other fasteners.

Accordingly, with relatively simple stamping or pressing manufacturing and assembly steps a heavy duty yet light weight structure hanger clamp can be formed providing the performance of cast hangers but none of the uncertainties such as cost, availability or performance from lot to lot.

To the accomplishment of the foregoing and related ends the invention, then, comprises the features hereinafter fully described and particularly pointed out in the claims, the following description and the annexed drawings setting forth in detail certain illustrative embodiments of the invention, these being indicative, however, of but a few of the various ways in which the principles of the invention may be employed.

### BRIEF DESCRIPTION OF THE DRAWINGS

FIG. 1 is a perspective view of one form of heavy duty fabricated hanger clamp in accordance with the invention showing the rod in place;

FIG. 2 is a perspective view of the clamp of FIG. 1 from the opposite end but without the rod;

FIG. 3 is a similar view of a clamp slightly modified;

FIG. 4 is a profile of a side plate which may be used to form a variety of types of fabricated heavy duty clamps;

FIG. 5 is a perspective view of a clamp with side plates of FIG. 4 and with a spacer block formed of laminations;

FIG. 6 is a rear perspective view of the clamp of FIG. 5;

FIG. 7 is a front perspective view of the clamp of FIG. 5 showing the laminated block;

FIG. 8 is a perspective of another form of clamp;

FIG. 9 is a perspective showing the rear of the clamp of FIG. 8;

FIG. 10 is a perspective showing the bottom of the clamp of FIG. 8;

FIG. 11 is a fragmentary transverse section through one of the spacer blocks and side plates showing how they are joined and taken from the line 11-11 of FIG. 8 looking to the rear;

FIG. 12 is a fragmentary partially-in-section embodiment of a clamp gripping a structure flange and with a rod in place;

FIG. 13 is a fragmentary section taken through the clamp screw of FIG. 12 but with the flange removed;

FIG. 14 is of a somewhat modified clamp using a laminated lower jaw spacer block; and

FIG. 15 is a fragmentary section of the clamp of FIG. 14 taken through the clamp screw.

### DETAILED DESCRIPTION OF THE PREFERRED EMBODIMENTS

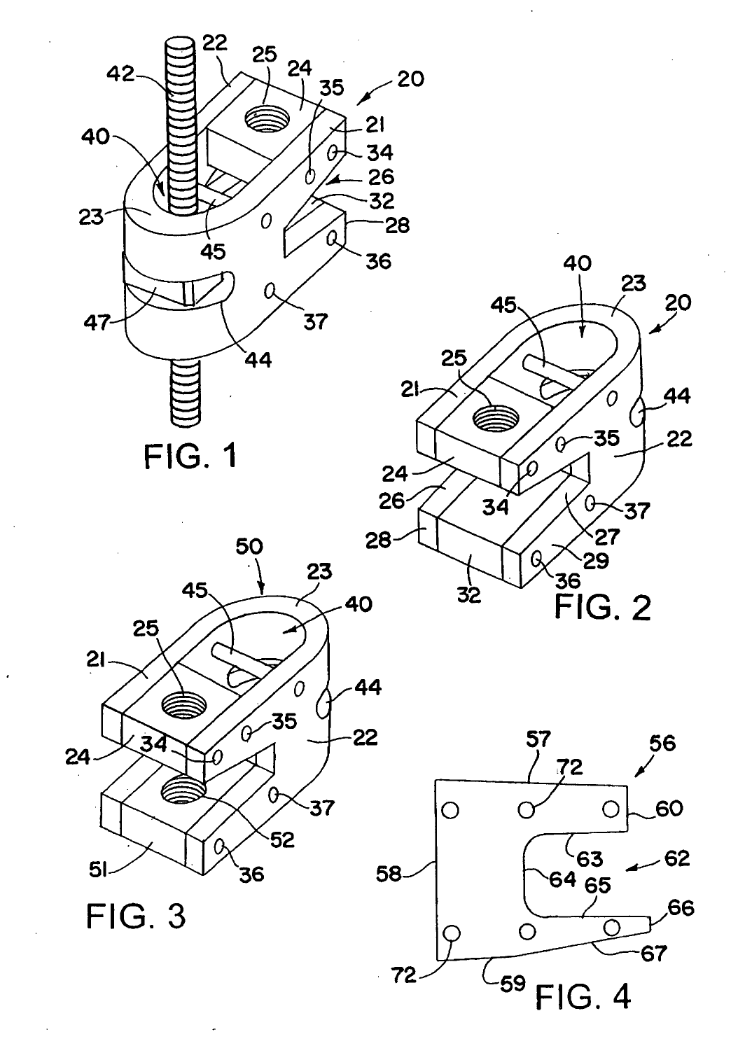

Referring initially to the embodiment illustrated in FIGS. 1 and 2 it will be seen that the fabricated heavy duty clamp shown generally at 20 is formed with two side walls 21 and 22 bent into the generally U-shape shown so that one wall is an extension of the other through the bent bight portion 23.

Secured between the projecting legs 21 and 22 is a spacer block 24 provided with a center tapped hole 25.

The edges of the side plates away from the bight portion 23 are each provided with a notch or cutout indicated at 26 and 27, respectively. The notches are horizontally aligned and form jaw openings with the bottom edge of the openings projecting beneath the tapped hole 25. Positioned between the bottom projecting ends 28 and 29 of the side plate is a bottom block 32.

The top block 24 is held in place by two pin rivets shown at 34 and 35. Similarly, the bottom block 32 is held in place by transverse pin rivets 36 and 37. The pin rivets and blocks may be assembled and coined, or swaged, in a relatively simple stamping operation, and when assembled form a unitary structure for the fabricated heavy duty structure clamp illustrated.

It is noted that the bottom of the jaw openings are generally parallel to the bottom of the structure clamp and are designed to accommodate the bottom of a projecting flange which will fit within the jaw. A clamp screw, not shown, threaded in the opening 25 is then tightened on top of the projecting flange to clamp the illustrated structure firmly to the flange edge.

Beyond the interior of the jaw opening, and thus the lateral edge of the flange, the clamp structure has a vertically extending through-opening illustrated generally at 40. The through-opening is generally centered with respect to the semi-circular bight portion 23. This through-opening accommodates a threaded rod shown generally at 42 in FIG. 1. This semi-circular portion is also provided with a horizontally extending rearwardly opening slot shown generally at 44. A transverse rivet pin 45 extends between the walls just above the slot 44. The slot and rivet pin act to capture a nut shown generally at 47 in FIG. 1. The nut 47 may be a conventional nut with an end of the rod 42 threaded through the nut, or, as illustrated, it may be a two part slip-on nut such as shown in Applicants' Assignee's U.S. Pat. No. 6,050,766. Such a nut may be inserted on the rod laterally rather than from the end, and once inserted on the rod is captive between the slot 44 and the transverse rivet pin 45. The rod of course extends vertically offset from the jaw openings and, of course, the edge of any flange clamped therein. It is noted that the block 32 at the bottom of the jaw simply bridges the side plate projections 28 and 29 and provides a substantial clamping area engaging the bottom of the flange as the clamp screw is tightened in the hole 25.

In any event the fabricated heavy duty structural clamp seen in FIGS. 1 and 2 may very quickly be made in a stamping or pressing operation and has all of the attributes of a heavy duty cast beam clamp while none of the noted drawbacks.

Referring now to the embodiment of FIG. 3 it will be seen that the clamp shown generally at 50 in FIG. 3 has all of the same parts as the clamp shown at 20 in FIGS. 1 and 2 except that the bottom spacer block 51 is provided with a tapped hole 52 which is aligned with the tapped hole 25 in the top spacer block 24. In this manner a threaded rod may be supported from the clamp 50 shown in FIG. 3 either by extending through the offset opening 40 offset from the edge of the flange or by being threaded into the hole 52 and the end being tightened or abutted against the bottom of the flange clamped in the jaw openings. Even with the threaded opening 52 the bottom block provides a substantial area for clamping to the bottom of any flange or structure from which the rod or rods are to be suspended.

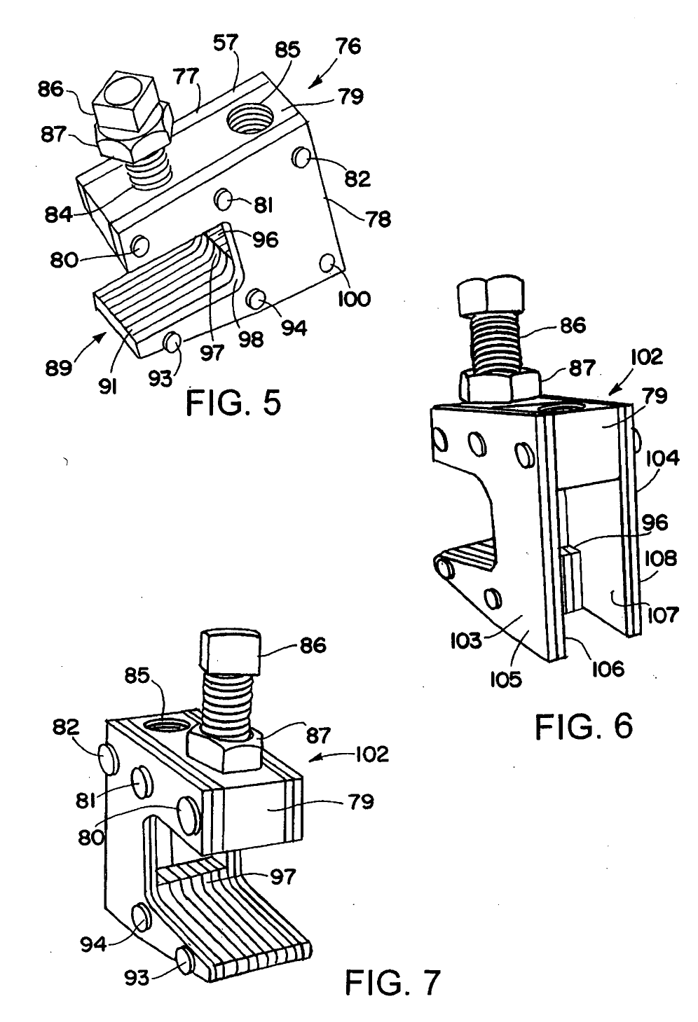

Referring now to FIG. 4 and the embodiment of FIG. 5, FIG. 4 illustrates a side plate profile shown generally at 56 which may be used to form fabricated heavy duty structural clamps with low cost stamping, blanking, or press operations. The plate 56 includes a top edge 57, a rear edge 58 and a bottom edge 59. The front edge 60 includes a jaw notch 62 with a horizontal top 63, a vertical rear or interior 64, and a horizontal bottom 65. The bottom 65 projects further than the top edge 60 to terminate in tip 66. From the projecting tip 66 the bottom 67 extends at a shallow angle back to the bottom edge 59. The plates may be provided with one or more holes indicated at 72 to accommodate transverse rivet pins, fasteners, or the like. In some embodiments, the side plate profile may be provided with notches or other shape holes to enable the spacing blocks properly to be secured spanning the side plates in order to form a unitary fabricated heavy duty structural clamp.

Referring now to the embodiment of FIG. 5 there is illustrated a heavy duty fabricated clamp shown generally at 76, which comprises two relatively thick side plates 77 and 78 of the profile shown in FIG. 4. A top spacer block 79 is provided between the tops of the side plates and held in place by rivets or fasteners shown at 80, 81 and 82. The spacer block is elongated and generally rectangular both transversely and longitudinally. The spacer block may have the same length as the top edge 57 of the side plates. The spacer block 79 also is provided with two primary tapped holes indicated at 84 and 85. The hole 84 accommodates clamp screw 86 on which is threaded locknut 87. The threaded hole 85 may receive a threaded rod having external threads of the same dimension.

Positioned between the bottom jaw notch edges of the side plates 77 and 78 is a spacer block shown generally at 89 which is formed of a series of vertically oriented plate laminates shown generally at 91. In the embodiment of FIG. 5 there are illustrated 6 laminates forming the block between the lower edges of the jaw and these laminates are unitized and held to the side plates by the rivet pins or fasteners 93 and 94. Each of the plates of the laminate includes an interior upwardly extending projection 96 which forms a shoulder 97 horizontally aligned with the rounded interiors 98 at the interior of the lower edge of the jaw notch in each side plate. It has been found that it is easier and less expensive to form the bottom jaw block shown generally at 89 from a series of plates or sheets that may be formed on a press rather than forming a solid block with the complex machining operations needed to form the various surfaces and the angles required. Moreover, the laminated lower block provides an improved gripping surface for the underside of the beam flange when the clamping screw 86 is tightened against the top of the flange.

It is noted that the side plates 77 and 78 may be somewhat thicker than the plates forming the laminate lower block 89 or they may be of the same thickness.

As indicated in FIG. 5 the side plates are provided with the hole seen at 100, but that hole is not used. Conversely, in the stamping or blanking operation, the hole 100 may be omitted.

Referring now to the embodiment of FIGS. 6 and 7, there is illustrated a clamp which is, in all major respects, the same as the embodiment 76 in FIG. 5. The embodiment 102 is however provided with dual side plates seen at 103 and 104. The side plate 103 comprises two side plates 105 and 106 while the side plate 104 comprises side plates 107 and 108. The side plates have the same profile as seen in FIG. 5 or FIG. 4, for that matter. By forming the side plates with two laminated side plates enables the side plates to be formed from thinner stock providing less wear and tear on the expensive press tooling required to make the plates. FIG. 7 illustrates more clearly the laminated vertical plates held to each other and to the side plates by the fasteners or rivet pins 93 and 94 and the interior shoulder 97 formed at the interior of the laminated lower block. The transverse holes at the lower rear corners of the side plates have been omitted. Other than the somewhat thinner dual side plates, the embodiment of FIGS. 6 and 7 is essentially the same as that of FIG. 5.

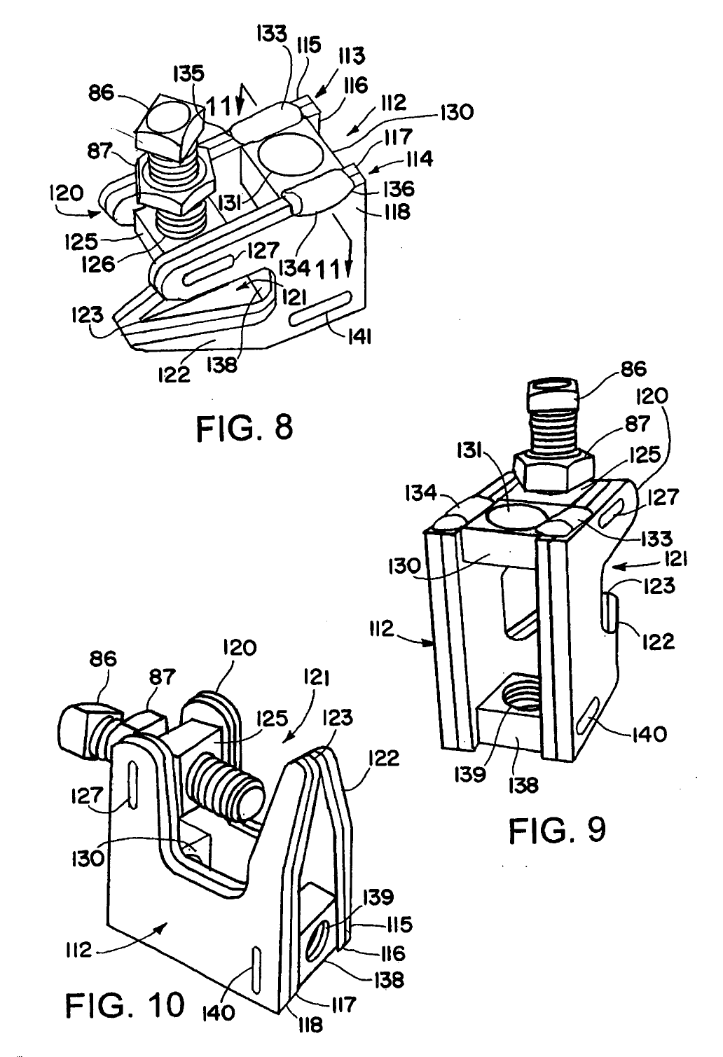

Referring now to the embodiment shown generally at 112 in FIGS. 8-11, it will be seen that the fabricated heavy duty structure clamp shown includes side walls 113 and 114, each formed of a pair of plates. The wall 113 is formed of plates 115 and 116 while the wall 114 is formed of plates 117 and 118. The plates have the general profile as seen in FIG. 4, but the top front is rounded as indicated at 120 above the jaw notches 121 while the lower projecting portions of the jaw indicated at 122 are bent or pressed together so that the two wall projecting tips come together as indicated at 123 to form a somewhat pointed tip to the underside of the jaw opening.

The heavy duty structure clamp of FIGS. 8-11 includes three separate spacer blocks spanning between the side walls of the clamp. One spacer block is shown at 125 which extends above the jaw openings 121 and includes a tapped primary hole 126 for the clamp screw 86 on which is threaded the locknut 87. The spacer block 125 includes two somewhat thinner projections which extend through aligned holes in the side wall plates. The projecting ends are then coined in the assembly process to form the somewhat elongated or oblong rivet heads indicated at 127.

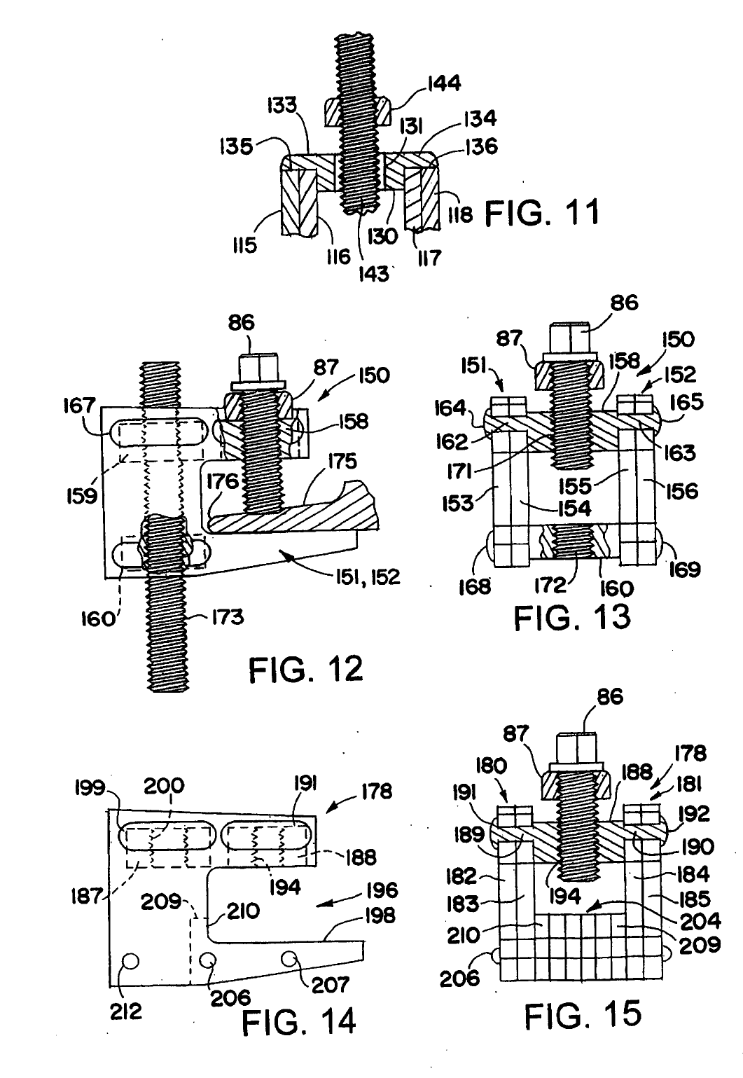

Another spacer block seen at 130 is spaced just to the rear of the spacer block 125 and includes a primary clearance hole 131. The block 130 includes two horizontally extending wings at the top indicated at 133 and 134 seen more clearly in FIG. 11 which fit in notches on the top edges of the walls 113 and 114 as indicated at 135 and 136, respectively. In the forming operation the ends of the projections are coined or swaged to lock into such notches firmly holding the spacer block 130 in place. In addition, or in lieu of the swaging or coining operation the wings may be welded along the top edges of the walls. In any event the spacer block 130 bridges and spans the two side walls of the heavy duty structure clamp locking them together and includes the clearance hole 131.

Positioned below the spacer block 130 is another spacer block 138 which includes primary tapped hole 139. The spacer block 138 includes laterally extending wings which project through slots in the wall plates and which are then coined or swaged to form the oblong rivet heads seen at 140 and 141.

With the three spacer blocks each with a primary hole spanning the side walls of the heavy duty structure clamp a rigid and low cost clamp is provided having the benefits of a cast clamp but not the problems associated with such cast clamps.

The clearance hole in the top spacer block enables a threaded rod 143 seen in FIG. 11 to be threaded into the hole 139 from the top, if desired, and a locknut 144 may be positioned on the rod and tightened against the top of the spacer block 130. The locknut may be conventional or may be of the slip-on type as noted above.

Referring now to the embodiment 150 shown in FIGS. 12 and 13, it will be seen that the side walls 151 and 152 having the profile shown in FIG. 4 are made from paired plates 153, 154, and 155, 156, respectively. The laterally spaced side walls are interconnected by three different spacer blocks shown at 158, 159, and 160.

As seen more clearly in FIG. 13 each spacer block includes a horizontally projecting wing as indicated at 162 and 163 projecting through aligned holes in the side walls and in the manufacturing operation the ends of the wings are coined or swaged into the oblong rivet heads seen at 164 and 165, respectively. The rivet heads for the blocks 159 are shown at 167 while the rivet heads for the block 160 are shown at 168 and 169.

The spacer block 158 which is positioned over the jaw notches includes a tapped hole 171 receiving clamp screw 86 on which is mounted the locknut 87. The bottom spacer block 160 includes tapped hole 172 adapted to receive the threaded rod 173. The top spacer block 159, like the block of the FIG. 6 embodiment may include a clearance hole, not shown.

Referring to FIG. 12 it will be seen that the heavy duty structural clamp 150 has been clamped to a beam flange such as seen at 175, and in such position the spacer blocks 159 and 160 are offset from the edge 176 of the beam flange. The heavy duty structure clamp may then support the threaded rod 173 vertically extending in the offset position shown clear of the beam and its flange.

Referring now to FIGS. 14 and 15 it will be seen that the embodiment shown generally at 178, like that of FIGS. 12 and 13 includes side walls 180 and 181 formed of paired plates shown at 182, 183, and 184, 185 respectively. These plates have the profile shown in FIG. 14 and also in FIG. 4.

The side walls are joined at the top by two spacer blocks seen at 187 and 188, both of which are provided with horizontally extending wings 189 and 190 with the ends of such wings being swaged or peened on the exterior of the walls to form the oblong heads seen at 191 and 192, respectively. The spacer block 188 is provided with the tapped hole 194 to receive the clamp screw 86 which includes the locknut 87. The clamp screw is thus positioned above the jaw opening 196 and opposite the horizontal extending portion of the bottom of the jaw indicated at 198. The spacer block 187 is supported by the wings which are coined or swaged into the oblong rivet heads indicated at 199 and includes a primary threaded hole 200 which is adapted to mesh with the threads of a vertically extending threaded rod offset or beyond any flange clamped in the jaw opening.

Positioned between the side walls at the lower part of the jaw opening is a laminated block shown generally at 204. As illustrated the laminated block includes six separate sheets or plates and the block is held in place by transverse rivet pins seen at 206 and 207. The plates forming the laminations include an upwardly extending projection indicated at 209 at the rear forming shoulder 210. The laminated block forms a strong clamping and stop surface for the flange or other structural element to which the heavy duty structural clamp is secured. The laminated block can be made and assembled in a stamping, blanking, or pressing operation more easily and at less cost than a solid block can be machined to the complex profile shape shown in FIG. 14. The hole indicated at 212 in FIG. 14 need not be used or omitted.

It can now be seen that there is provided a low cost light weight yet heavy duty structural clamp which may be formed by laminating relatively thin slices together. The lamination itself may be unitized by riveting, welding, bolting or peening the ends of the wings of the insert nuts or blocks to form a rivet head that locks the laminates in place. The spacer blocks may be formed from conventional T-nut shapes or can be formed from T-rail or DIN rail. It will also be appreciated that the various arrangements of the spacer blocks may vary widely as well as also the provision of either tapped holes or clearance holes. While a tapped hole is necessary for the clamp screw it is not necessary for the threaded rod since the rod may be placed through a clearance hole and held in hanging position by a conventional or slip-on nut. It may also be held by a jam-nut or a spring steel bobby pin clip.

There is thus provided a low cost light weight heavy duty structural clamp having all of the advantages of cast and machined structural clamps but none of the disadvantages.

Although the invention has been shown and described with respect to certain preferred embodiments, it is obvious that equivalent alterations and modifications will occur to others skilled in the art upon the reading and understanding of this specification. The present invention includes all such equivalent alterations and modifications, and is limited only by the scope of the claims.

1. A heavy duty hanger clamp comprising:
a spacer block having at least one hole,
side plates secured to the spacer and each having a notch having one side extending beneath said hole,
and threads in said hole to receive a clamp screw to clamp a structure and the like against said one side of said notch, to secure said hanger to said structure, and an opening between said side plates offset from said hole, whereby a rod and the like may be supported from the hanger clamp offset from the structure.

2. A hanger clamp as set forth in claim 1 wherein said side plates are both formed from one U-shape plate.

3. A hanger clamp as set forth in claim 2 including a threaded rod extending through said opening with a nut on said rod, and means formed by said plates to capture the nut and rod.

4. A hanger clamp as set forth in claim 3 wherein said opening is formed in said spacer block secured between said plates.

5. A hanger clamp as set forth in claim 4 wherein said opening is formed in a second spacer block between said plates.

6. A hanger clamp as set forth in claim 1 including a spacer block between said plates offset from said notch, and a hole in said last mentioned spacer block for supporting a threaded rod.

7. A structure hanger comprising:
a spacer having two holes,
side plates secured to the spacer and each having a notch having one side extending beneath one of said holes,
and threads in said one of said holes to receive a clamp screw to clamp a structure and the like against said one side of said notch, to secure said hanger to said structure, whereby a rod and the like may be supported from the structure using the other of said holes.

8. A structure hanger as et forth in claim 7 including at least two side plates on each side of said spacer.

9. A structure hanger as set forth in claim 7 including a vertically oriented lamination of plates secured between said side plates, each having a top edge aligned with said one side of said notch.

10. A structure hanger as set forth in claim 9 including transverse rivets securing said lamination of plates to said side plates.

11. A structure hanger as set forth in claim 7 wherein said side plates on each side of said spacer are formed from the legs of a single plate bent to a U-shape configuration.

12. A structure hanger as set forth in claim 7 wherein said side plates are angled toward each other at said one side of said notch.

13. A structure hanger as set forth in claim 7 wherein said side plates are joined at the edge opposite the notch.

14. A structure hanger as set forth in claim 7 wherein said side plates are the legs of at least one U-shape plate having a bight portion at the end opposite the notch.

15. A structure hanger as set forth in claim 7 including a at least two blocks forming said spacer and interconnecting said side plates.

16. A structure hanger as set forth in claim 15 wherein one of said holes and the other hole are in the respective blocks.

17. A structure hanger as set forth in claim 16 including a third block interconnecting said side plates interiorly of said notch.

18. A structure hanger as set forth in claim 7 including a hole in said third block aligned with the other of said holes.

19. A structure hanger as set forth in claim 7 including a threaded rod extending through said other of said holes, and an adjustable cleat on said rod above the other of said holes to hold said rod suspended.

20. A structure hanger as set forth in claim 19 wherein said adjustable cleat is a nut threaded on said rod.

21. A structure hanger as set forth in claim 19 wherein said adjustable cleat is a slip-on nut.

22. A structure as set forth in claim 19 wherein the other of said holes is a clearance hole.

23. A structure hanger as set forth in claim 19 wherein said adjustable cleat is a two-part nut which may be installed on the rod laterally.

24. A structure hanger as set forth in claim 7 including a further spacer between said plates below the notches, and a threaded hole in said further spacer adapted to receive a threaded rod.

25. A structure hanger as set forth in claim 24 wherein said last mentioned threaded hole is generally vertically aligned with said first mentioned threaded hole.

26. A structure hanger comprising side plates, a top block secured to said side plates, a threaded hole in said top block, a notch in each said side plates extending beneath said threaded hole whereby a clamp screw in said threaded hole will clamp a structure against one side of the notches, a second block secured between said side plates, and a hole in said second block to receive a threaded rod.

27. A structure hanger as set forth in claim 26 wherein said second block is positioned between said plates to clear said notches.

28. A structure hanger as set forth in claim 26 wherein said second block is positioned beneath said notch.

29. A structure hanger as set forth in claim 28 wherein the holes in said first and second blocks are generally aligned.

30. A structure hanger as set forth in claim 27 including a third block positioned between said plates to clear said notches and having a hole aligned with the hole in said second block.

31. A structure hanger as set forth in claim 27 including a third block positioned beneath said notch and having a hole generally aligned with the hole in said first mentioned block.

32. A structure hanger as set forth in claim 30 including a fourth block positioned beneath said notch and having a hole generally aligned with the hole in said first mentioned block.

33. A structure hanger as set forth in claim 32 including threads in said hole in said fourth block adapted to receive a threaded rod.

34. A structure hanger as set forth in claim 33 including transverse projections joining said blocks to said side plates.

35. A structure hanger as set forth in claim 33 including holes in said side plates accommodating said projections.

36. A structure hanger as set forth in claim 35 wherein said projections are formed from said block and are peened on the exterior of said plates.

37. A structure hanger as set forth in claim 32 including more than one hole in one or more of said blocks to permit other types of fasteners to be secured to said one or more of said blocks.

38. A structure hanger comprising:
a top spacer,
offset holes in said top spacer,
side plates secured to said top spacer,
notches in a vertical edge of said side plates for accommodating a beam flange and the like, and underlying one of said holes,
and threads in said one of said holes for receiving a clamp screw for clamping a beam flange and the like against the opposite sides of the notches.

39. A structure hanger as set forth in claim 38 wherein said top spacer is two separate blocks, one for each hole.

40. A structure hanger as set forth in claim 38 including a threaded rod in the other of said holes clear of the beam flange.

41. A structure hanger as set forth in claim 40 including a cleat on said rod above the other of said holes holding the threaded rod in place.

42. A structure hanger as set forth in claim 40 including threads in the other of said holes adapted to mesh with those of the threaded rod.
